(19) United States
(12) Patent Application Publication
(10) Pub. No.: US 2010/0013335 A1
(43) Pub. Date: Jan. 21, 2010

(54) Permanent magnet motor generator set

(76) Inventor: Richard Ellis Strube, Vestal, NY (US)

Correspondence Address: Richard E. Strube, 408 Elmhaven Dr., Vestal, NY, 13850, US

(21) Appl. No.: 12/176,388

(22) Filed: Jul. 20, 2008

(51) Int. Cl. H02K 21/00; H02K 53/00

(52) U.S. Cl. 310/152; 415/916

(57) ABSTRACT

The invention is directed to the method of utilizing unbalanced non-equilibrium magnetic fields to induce a rotational motion in a rotor, the rotor moves with respect to the armature and stator. The invention, a three (3) tier device (armature, rotor, and stator) has the armature and stator being fixed in position with the rotor allowed to move freely between the armature and stator. To induce a rotational motion, the rotor, in its concave side uses unbalanced non-equilibrium magnetic fields created by having multiple magnets held in a fixed position by ferritic or like materials to act upon the magnets imbedded in the armature. The rotor, in its convex side has additional unbalanced non-equilibrium magnets and additional pole pair magnets to create a magnetic flux that moves with the moving fixed position fields to cut across closely bonded coils of wire in the stator to induce a voltage and current that is used to generate electrical power. In the practice of the invention multiple permanent magnets of varying strength are geometrically positioned in multiple groups to produce a motive power in a single direction with the remainder of the unbalanced magnetic flux positioned and being used to cut across the coils of wire to produce continuous electric power. In the practice of the invention the permanent magnet motor-generator set produces no pollutants nor does it create any greenhouse emissions during operation.

### FIELD OF THE INVENTION

The invention pertains to the field of motor-generator sets wherein the motive force created in the motor is proportional to the unbalanced non-equilibrium magnetic field flux. This motor generator set creates an unbalanced field flux by use of a specialized rotor constructed of systems of magnetic materials configured to create an unbalance in the poles that face the armature. This construction is accomplished by having each magnetic configuration having a polarity of poles where the magnetic flux between adjacent pole pairs is unbalanced but the magnetic flux summation about each configuration is zero. The rotor's magnetic systems have multiple poles on the side facing the armature creating a motive force that causes the rotor to move in a motor's characteristically rotary motion; the opposite side of this magnetic system has poles attached that face the stator. The stator facing poles force magnetic fields of flux to cut across coils of wire mounted in the stator to produce an EMF. This EMF, induced voltage from the coils of wire, is them captured, modified, and used in ways that are typical of current power generation systems.

### BACKGROUND OF THE INVENTION

Conventional electric motors employ magnetic forces to produce linear rotational motion. Conventional electric motors may employ permanent magnets in either the armature or stator components, but in the normal art of a conventional motor the use of permanent magnets in either the armature or stator requires a switching means to control the energization of the electromagnets to produce the motive power that acts on the fields of the permanent magnets.

This motor uses an unbalanced magnetic flux field created in the rotor to replace the switching means of the conventional motor. The motor is based on a mathematics paper by B. Haisch, A. Rueda, and H. E. Puthoff; Inertia as a zero-point field Lorentz force, Physical Review A, 1994; 49(2):678-94 and prior art in the form of U.S. Pat. No. 4,151,431—Permanent magnet motor (Johnson Apr. 24, 1979) has demonstrated that a motor can be made using permanent magnetics in both the Armature and rotor. This adaptation extends this concept by adding additional layers of magnetics to the rotor and coils of wire combined with high permeability materials in the form of a stator to create a motor-generator. To induce the magnetic flux into the coils of wire each magnetic system in the rotor is modified such that multiple pole pairs face the coils of wire mounted in the stator. To accomplish this each magnetic system is constructed of permanent magnetics and high magnetic permeability materials to have both a concave side and a quasi convex side. The concave side, facing the armature, causes the motors characteristically rotary motion by having the strength of the magnetic materials unbalanced non-equilibrium flux propel the rotor in one direction. The opposite, convex side of this system has additional magnetic materials aligned to create both a primary pole pair plus a secondary pole pair such that the net flux about the system of permanent magnetics of the rotor is zero but the net flux between adjacent pairs is not zero.

The pole pairs adjacent to the coils of wire mounted in the stator force magnetic fields of flux to produce an EMF in the coils of wire. This EMF, the induced voltage of the coils of wire, is them captured, modified, and used in ways that are typical of current power generation systems.

### SUMMARY OF THE INVENTION

It is an object of the invention to produce a motor-generator set that combines the motor and generator into a single functional unit. The motor portion of this motor-generator uses power gained by magnetic materials from the energy of zero point particles. The generator portion uses a novel approach in the rotor construction of adding extra magnetic materials to create a flux path that will engage coils of wire in the generator stator to produce a voltage (EMF) that can them be captured, modified, and used in ways that are typical of current power generation systems.

The invention, the motor-generator breaks down into two parts. The first part, the motor is based on a mathematics paper by B. Haisch, A. Rueda, and H. E. Puthoff; Inertia as a zero-point field Lorentz force, Physical Review A, 1994; 49(2):678-94 and prior art has demonstrated that a motor can be made using permanent magnetics in both the Armature and rotor (see U.S. Pat. No. 4,151,431—Permanent magnet motor (Johnson Apr. 24, 1979)). The second part, the electrical generator introduces a novel adaptation by adding additional permanent magnets to the rotor facing away from the armature to create a separate magnetic flux path that also adds to the unbalance in the flux of the rotor pole pair facing the armature to provide motive force. This adaptation extends this concept further by adding additional layers of coils of wire and high permeability materials to a stator to create the generator that is integral to the motor. What this project does is to combine these two devices into a single device, removing the inefficiency of having separate units for the motor and generator.

What makes this concept work is that electrical energy is additive, each motor-generator modular unit produces electrical energy from its output coils; energy that can be added from one motor-generator unit to another in the same manner as is currently used by large commercial grid networks where the power from one generator system is added to another. Therefore, if more energy is needed then can be produced by a single motor generator, additional units can be added until the level of needed power is reached. Once that level is reached then a properly sized electrical control can be used to condition the power to meet local, national, and/or international commercial interface requirements.

An additional benefit of this approach to the motor-generator construction is that no oil, coal, or gas is used to create greenhouse emissions or increase carbon pollution.

Ultimately the motor-generator will be used in three configurations:
the first configuration is a fixed or permanently located motor-generator,
the second configuration will have an increased physical mounting strength to withstand the strain of continuous vibration and shock associated with vehicle movement and is used as a source of electrical energy for the motors and control systems of an all electric vehicle.
the third configuration requires miniaturization to supply power to electrical devices for portable device configurations.

### BRIEF DESCRIPTION OF THE DRAWINGS

The aforementioned objects and advantages of the invention will be appreciated from the following description and accompanying drawings wherein:

FIG. 1 is a simplified front and side plan view of the motor-generator in accord with the invention. The front view shows the armature (1), rotor (3), and stator (5) in relative position to each other with the rotor (3) also shown in the side view. The side view shows the three (3) staggered stages of the rotor.

FIG. 2 is for clarity and shows a partial expansion of the front view from FIG. 1. FIG. 2 shows portions of the invention that were expanded for clarification of detail, showing the placement of accompanying magnets (2) in the armature and of the magnetic systems (4) in the rotor stage. The stator (5) shows the cut outs for the teeth in which the coils of wire (6) are placed about each tooth.

### DETAILED DESCRIPTION OF THE INVENTION

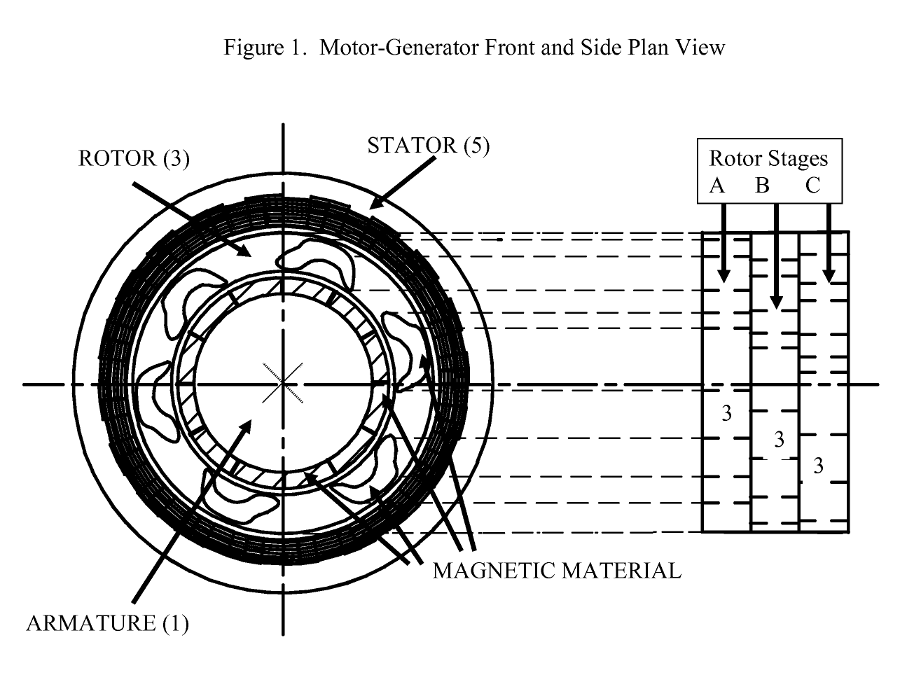

The motor-generator depicted in FIGS. 1 & 2 consists of three main parts; starting at the center and working outward is the armature, the rotor, and then the stator. The remainder of the motor-generator, the power electronics is not shown in the figures because this invention is not claiming new or additional capabilities in this field and the concepts and construction of the electronics is widely known in the field of electric power generation. The armature (1) and stator (5) are fixed in position and only the rotor (3) moves. The armature (1) consist of magnetics (2—see hatched area) all orientated in the same direction about the armature central point and fixed in position.

The rotor (3) consists of three stages, A, B, & C. Each stage is identical, each stage is offset from the adjacent one by one third, and the combined rotor system is dynamically balanced. The rotors' magnetic system (4) is constructed of high permeability material with magnets embedded in the high permeability material to have multiple poles, multiple poles that face the armature and multiple poles that face the stator. The side view of FIG. 1, for clarity, only shows the rotors (3) three stages and their relative positioning in respect to each other

The stator (5) is constructed of high permeability material shaped to have teeth like slots facing inward toward the rotor. Each tooth is encased by a coil of wire (6). The leads of each coil of wire (6) go to the input of the power electronic tank circuits.

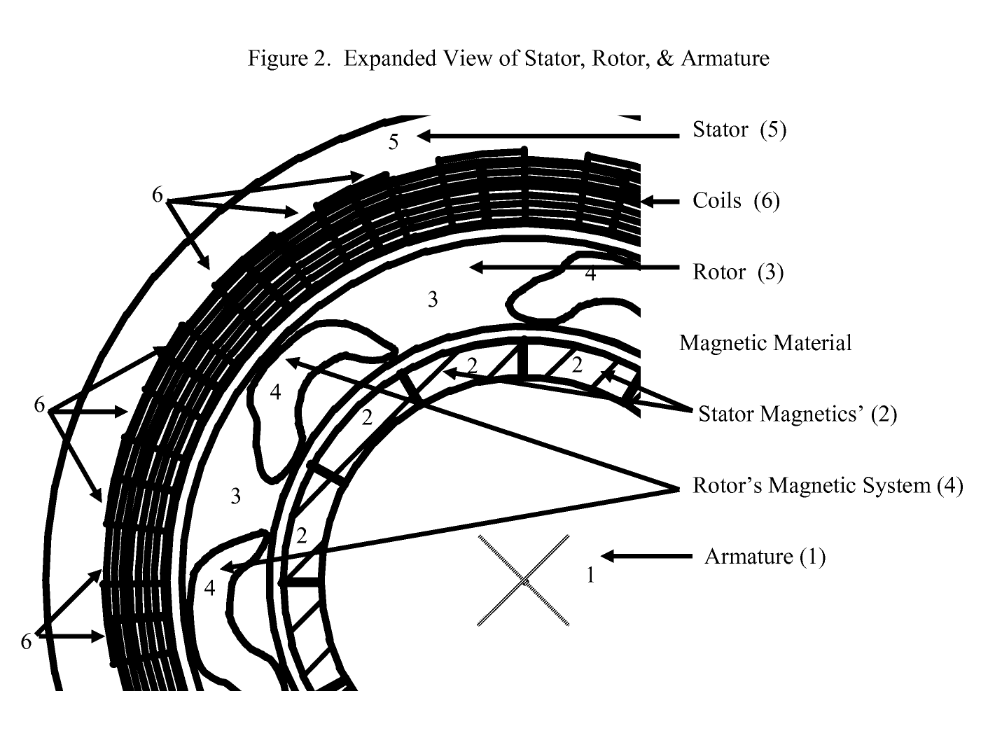

FIG. 2 is a partial expanded view of the armature (1), rotor (3), and the stator (5) to allow enough space to identify the sections mentioned above.

What is claimed is:

1. A motor-generator set comprising of a permanent magnet motor in combination with a permanent magnet generator. The permanent magnet generator being a free running generator. The electric output of the free running generator is controlled and conditioned by advanced control techniques to produce alternating voltages at fixed frequencies.

2. In a permanent magnet motor as in claim 1 wherein said armature track magnets in side-by-side relationship being mechanically interconnected and having generally equal spacing between adjacent magnets and like pole orientation defining a circle of a linear configuration having an axis perpendicular and equidistant from the poles.

3. In a permanent magnet motor as in claim 1 wherein a rotor that consists of a system of multiple magnets being staggered with respect to each other in an asymmetrical circumferential spacing being held in this fixed position by ferritic or like materials of high magnetic field permeability as a concentrating means and mounted with respect to the armature such that it can rotate about the axis that coincides with the armature axis as in claim 2. The rotor magnet system configuration is shaped with a concave side and a convex side, the concave side being disposed toward the armature with an unbalanced level of flux at each end and the convex side disposed toward the stator also having a flux that is unbalanced.

4. In a permanent magnet generator as in claim 1 wherein concentric bonded coils of wire that are associated with a stator of high magnetic field permeability material are circumferentially uniformly closely spaced to said rotor in an orientation being permanently affixed to the stator and defining a circle having an axis that coincides with the axis of the armature as in claim 2.

5. In a permanent magnet motor as in claim 1 by combining the permanent magnet motor in combination with the a permanent magnet generator removes the inefficacity of having separate units for the motor and generator.

6. In a permanent magnet motor as in claim 1 wherein said rotor magnets having unbalanced flux on the convex side as in claim 3 having fixed position fields of magnetic flux induce a voltage in the coils of wire as the fields of flux on the convex side cut through the closely bonded coils of wire as in claim 4 in the stator as the rotor coincides and rotates about an axis to generate electrical power by electromagnetic induction. The axis of the rotor coincides with the axis of the armature as in claim 2.

7. The invention is directed to the method of utilizing unbalanced magnetic fields of the rotor's concave side to induce a rotational motion of the rotor with respect to the armature. The rotor's convex side has fixed position magnetic flux fields that move with the rotor and in so doing cause the magnetic flux to cut across closely bonded coils of wire attached to the stator to induce a voltage that is used to generate electrical power.

8. In the practice of the invention the rotor is constructed of multiple permanent magnets of varying strength that are geometrically positioned in multiple groups having unbalanced flux on the concave side to produce a motive power in a single direction with the remainder of the unbalanced magnetic flux combined with additional magnetic paired poles on the convex side and positioned such that the convex side magnetic flux is used with the coils of wire mounted to the stator to produce continuous electric energy/power.

9. In a permanent magnet motor-generator set as in claim 1 wherein said motor-generator set produces no pollutants nor does it create any greenhouse emissions during operation.

10. In a permanent magnet motor-generator set as in claim 1 wherein said motor-generator set when mounted to withstand the strain of continuous vibration and shock the permanent magnet motor-generator set can be the prime mover for a vehicle's power system.

11. In a permanent magnet motor-generator set as in claim 1 wherein said motor-generator set when miniaturized can provide prime motive power for electrical devices of a portable configuration.
